(19) United States
(12) Patent Application Publication
(10) Pub. No.: US 2009/0077297 A1
(43) Pub. Date: Mar. 19, 2009

(54) Method and system for dynamically reconfiguring PCIe-cardbus controllers

(76) Inventors: Hongxiao Zhao, Wuhan (CN); Wei Yao, Wuhan (CN); Xiaoguang Yu, Wuhan (CN)

Correspondence Address: Wang Law Firm, Inc., 4989 Peachtree Parkway,, Suite 200, Norcross, GA, 30092, US

(21) Appl. No.: 11/900,935

(22) Filed: Sep. 14, 2007

(51) Int. Cl. G06F 9/50; G06F 13/20

(52) U.S. Cl. 710/314; 718/104

(57) ABSTRACT

A method for configuring a computer system. The method includes allocating a first plurality of default resources to a plurality of devices of the computer system. Then a PCIe-CardBus controller in the computer system is reconfigured with a plurality of allocable resources that are available to the PCIe-CardBus controller. The method further comprises enumerating the plurality of devices of the computer system by an Operating System (OS) of the computer system for detecting a plurality of un-configured devices in the computer system. According to the enumeration, the OS allocates a second plurality of default resources to the plurality of un-configured devices.

### TECHNICAL FIELD OF THE INVENTION

The invention relates to a method for configuring computer peripheral devices, and more particularly to a method for dynamically reconfiguring devices.

### BACKGROUND OF THE INVENTION

In a computer system, there are various buses for interconnecting a host processor with other modules and devices, and transferring data between them. A bus contains a series of parallel electrical lines through which data can be transferred. In the modem market, there are two types of buses, system buses and I/O buses, which are applied to a computer system. The system buses, such as Backside Bus (BSB) and FrontSide Bus (FSB), are used to couple the host processor to the modules and devices in the system. The Backside Bus (BSB) can be used to couple the host processor to a L2 cache. The FrontSide Bus (FSB) can be used to couple the host processor to the main memory formed by Random Access Memory (RAM), and is also called memory bus. The I/O buses, such as Accelerated Graphics Port (AGP), Peripheral Component Interconnect (PCI), PCI eXtended (PCI-X), PCI Express (PCIe), Universal Serial Bus (USB), IEEE 1394 (Firewire), CardBus, ExpressCard, are capable of providing a conduit for data to be transferred between the modules or devices of the computer system.

It was well known to those skilled in the art that PCI Express is a newly developed industry bus standard, which is an improvement on PCI. Like the PCI bus standard, the PCI Express bus standard is also specified and maintained by an international organization, PCI Special Interest Group (PCI-SIG).

CardBus is a 32-b it version of 16-bit Personal Computer Memory Card International Association (PCMCIA) standard. The 16-bit PCMCIA technology is known as PCMCIA Revision 2 (R2), and the 32-b it CardBus technology is called Revision 3 (R3). CardBus is designed as backward compatible with PCMCIA R2. Both CardBus and PCMCIA R2 cards can be employed in a single slot.

A PCIe-CardBus controller, which is also called a PCIe-CardBus bridge, is actually an interconnection device for interconnecting PCI Express bus and CardBus bus. The PCIe-CardBus controller extends a PCI Express bus to a CardBus slot, through which a CardBus card or a PCMCIA R2 card is allowed to operate in a PCI Express system. Similar to other PCI and PCI Express device, the PCIe-CardBus controller should be enumerated and configured by a Basis Input/Output System (BIOS) or an Operating System (OS), such as Windows 2000®, Windows XP® and Windows Server 2003®, and should be provided with sufficient resources so as to operate effectively.

Referring to PRIOR ART FIG. 1, a conventional method 100 for configuring a PCIe-CardBus controller in a computer system by a BIOS or an OS in the prior art is illustrated. At 102, after the computer system is powered on, the BIOS scans buses and devices of the system, and allocates default resources from parent devices to child devices, from primary buses to secondary buses. By executing the BIOS code, the topology of the computer system is detected, and devices and buses in the computer system are defined and numbered. The BIOS of the computer system accesses a configuration space in a device to write a bus number, a device number and a function number to a corresponding register therein, thus determines the position of a certain function of a certain device in the whole PCI Express topology. According to the detection, the BIOS makes a wide range of assumptions to manage the hardware, including budgeting resources and allocating these resources to each device. Besides, size of window needed for memory, prefetchable memory, and I/O for each device is estimated by the BIOS. The assumption and estimation are based on the data read from the configuration space registers of the devices. Those skilled in the art will appreciate that a PCI Express device occupies three independent address spaces: memory, IO and configuration. Although physical memories are distributed in every device and every bus, logical memory in the computer system is considered as a single contiguous part. Accordingly, the logical memory is shared by devices of all levels. IO space is also considered as one single contiguous part and shared by the devices. However, such estimation of the resources is too imprecise to make devices work effectively.

For example, since the most of the devices in the computer system, including the PCIe-CardBus controller, are coupled to a host processor through a Root Complex (RC), the RC is scanned and configured at first as a top level parent device. The RC is represented as a collection of many virtual PCI-to-PCI bridges. The PCIe-CardBus controller will be scanned and configured as a lower level child device of the RC. If the configuration code of the BIOS runs correctly, the PCIe-CardBus controller will receive default resources. If an error happens or if the PCIe-CardBus controller is not detected, the PCIe-CardBus controller will be an un-configured device and not be able to obtain proper resources to work effectively.

After the BIOS code is executed, a PCI bus driver of the OS start to work. At 104, the PCI bus driver enumerates devices and buses in the computer system, and assigns default resources to un-configured devices. The enumeration step of the PCI bus driver is similar to the detection step of the BIOS at 102. An Advanced Configuration and Power Interface (ACPI) driver can be optionally loaded and operate before this step 104, which is not shown in FIG. 1.

Problems may occur when the resources allocated to the devices are insufficient and are more apt to occur when the devices in the computer system are arranged with multi-level buses in a multiple hierarchical topology. In the prior art, either the BIOS or the OS assigns fixed resources to all the devices. Even if the PCI bus driver detects that a device did not obtain enough resources to work, the OS can not dynamically re-allocate more resources to the parent device to meet the requirement of the child devices since fixed resources has been assigned the parent device. When a device does not receive adequate resources, the device will not operate.

The OS assigns fixed default resources to the RC at first, and then some resources are passed to the PCIe-CardBus controller which is a child device of the RC. Consequently, the resources passed to the PCIe-CardBus controller are limited. The OS then assigns resources to the CardBus card from the PCIe-CardBus controller resources until those resources are used up. The resources assigned to the CardBus card may be insufficient, even though there are available resources in the computer system. For example, default resources that Windows XP® assigns to a PCI-to-PCI bridge are 1 megabyte (MB) of memory, 1 MB of prefetchable memory space, and 4 kilobyte (KB) of I/O space; default resources that Windows XP® assigns to a PCIe-CardBus controller which is a child device of the virtual PCI-to-PCI bridge of the RC are 4 KB of memory, 1 MB of prefetchable memory, and two 256-byte I/O of windows. When the CardBus card requires 2 MB of memory, the CardBus card coupled to the PCIe-CardBus controller will not function due to lack of resources.

It is to a system and method that enables dynamical reconfiguring of resources allocated to a PCIe-CardBus controller that the present invention is primarily directed.

### SUMMARY OF THE INVENTION

In one embodiment, there is provided a method for configuring a computer system. The method includes allocating a first plurality of default resources to a plurality of devices of the computer system. Then a PCIe-CardBus controller in the computer system is reconfigured with a plurality of allocable resources that are available to the PCIe-CardBus controller. The method further comprises enumerating the plurality of devices of the computer system by an Operating System (OS) of the computer system for detecting a plurality of un-configured devices in the computer system. According to the enumeration, the OS allocates a second plurality of default resources to the plurality of un-configured devices.

In another embodiment, there is provided a computer system capable of re-allocating a plurality of allocable resources to a PCIe-CardBus controller. The computer system includes a Central Processing Unit (CPU) for managing a plurality of devices of the computer system including the PCIe-CardBus controller. A root complex coupled to the CPU includes a plurality of root ports associated with a first plurality of virtual PCI-to-PCI bridges, and one of the first plurality of virtual PCI-to-PCI bridges is capable of coupling the PCIe-CardBus controller to the root complex. The computer system further includes a Basic Input Output System (BIOS) for cooperating with the CPU to boot up the computer system and load an operating system. The BIOS allocates a plurality of default resources to the plurality of devices of the computer system, computes the plurality of allocable resources which are available, and re-allocates the plurality of allocable resources to the PCIe-CardBus controller.

In still another embodiment, there is provided another computer system also capable of re-allocating a plurality of allocable resources to a PCIe-CardBus controller. The computer system includes a Central Processing Unit (CPU) for managing a plurality of devices of the computer system including the PCIe-CardBus controller. The computer system also includes an Operating System (OS) and a Basic Input Output System (BIOS) for cooperating with the CPU to boot up the computer system. A root complex includes a plurality of root ports associated with a first plurality of virtual PCI-to-PCI bridges, and one of the first plurality of virtual PCI-to-PCI bridges is capable of coupling the PCIe-CardBus controller to the root complex. A software driver installed in the OS is also included in the computer system for detecting a first plurality of default resources occupied by said plurality of devices of said computer system, computing the plurality of allocable resources which are available, and re-allocating the plurality of allocable resources to the PCIe-CardBus controller.

In still another embodiment, there is provided a method for reconfiguring one of a plurality of devices in a computer system. The method includes detecting a plurality of default resources occupied by the plurality of devices of the computer system and computing a plurality of allocable resources which are available. And the plurality of allocable resources is re-allocated to the device of the computer system.

### BRIEF DESCRIPTION OF THE DRAWINGS

Other advantages and novel features of the invention will become more apparent from the following Detailed Description when taken in conjunction with the accompanying drawings.

FIG. 1 is a prior art flowchart showing a method for configuring a PCIe-CardBus controller.

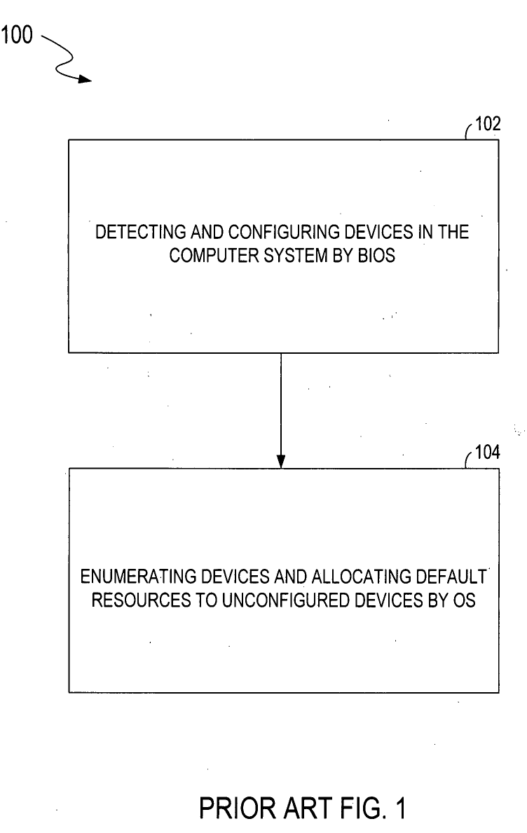

FIG. 2 is a diagram showing a computer system in accordance with one embodiment of the present invention.

FIG. 3 is a flowchart showing a method for dynamically reconfiguring a PCIe-CardBus controller in accordance with one embodiment of the present invention.

FIG. 4 is a flowchart showing a method for dynamically configuring a computer system in accordance with one embodiment of the present invention.

FIG. 5 is a flowchart showing another method for dynamically configuring a computer system in accordance with another embodiment of the present invention.

### DESCRIPTION OF THE INVENTION

Reference will now be made in detail to the embodiments of the present invention. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be appreciated by one of ordinary skill in the art that the present invention may be practiced without these specific details. In other instances, well known methods, procedures, components, and circuits have not been described in detail as not to unnecessarily obscure aspects of the present invention.

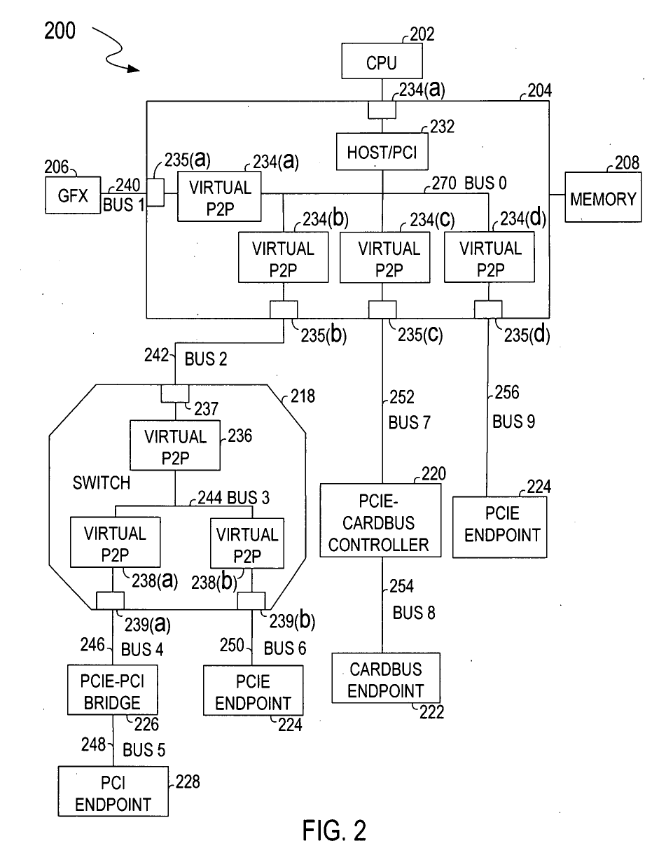

Referring to FIG. 2, a computer system 200 for configuring a PCIe-CardBus controller according to one embodiment of the present invention is illustrated. The computer system 200 can be a Personal Computer (PC) system, such as a desktop computer, a laptop computer, a desktop workstation or a server computer, which is structured with a Peripheral Component Interconnect Express (PCI Express) bus as shown in FIG. 2. As mentioned hereinabove, PCI Express has an assembly of serial, multiple point-to-point wired, individually clocked lanes, and uses the same load/store I/O architecture as PCI and PCI eXtended (PCI-X). The PCI Express is fully compatible with all PCI-based software models. Basis Input/Output System (BIOS) and Operating System (OS) that comply with the PCI software standard can be booted and operated without any change of the computer system 200 which complies with the PCI Express standard. However, it will be apparent to those skilled in the art that, in order to take advantage of the advanced features of PCI Express, software modification may be necessary.

Referring back to FIG. 2, the computer system 200 comprises multiple-level PCI Express buses for coupling various modules and devices with each other in a hierarchical topology. For example, as shown in the FIG. 2, the various modules and devices may include a Central Processing Unit (CPU) 202, a Root Complex (RC) 204, a graphics card (GFX) 206, a memory 208, a switch 218, PCI Express endpoints 224, a PCIe-CardBus controller 220, a CardBus endpoint 222, a PCI Express-to-PCI/PCI-X bridge (PCIe-PCI bridge) 226 and a PCI endpoint 228.

The CPU 202 cooperates with the BIOS and the OS to manage those modules and devices in the computer system 200 by interpreting instructions and processing the data contained in computer programs. The BIOS and OS serve as configuration software and are in charge of detecting and configuring the modules and devices in the computer system 200. The RC 204 in a PCIe-based computer system, such as the computer system 200, replaces and serves as Memory Controller Hub (MCH) and I/O Controller Hub (ICH) chipsets in a PCI-based computer system. By means of a host bridge 232 in the RC 204, the RC 204 translates the memory-mapped PCI Express configuration space accesses from the CPU 202 to PCI Express configuration transactions.

By means of the RC 204, the memory 208 is coupled to the CPU 202 through Frontside Bus (FSB), not shown, which is also known as “memory bus,” “processor bus” or “system bus.” The memory 208 can temporarily store instructions and data, and provide the stored information to the CPU 202 when the CPU 202 requests it. Further, the GFX 206 is also coupled to the CPU 202 through the RC 204 and a PCI Express link 240 for displaying images on an external display (not shown).

The switch 218 is used to couple a plurality of devices, such as the PCIe-PCI bridge 226 and the PCI Express endpoint 224, to one PCI Express port of the RC 204 through PCI Express links.

The PCI and PCI Express devices in the computer system 200, such as the PCIe-PCI bridge 226, the PCIe-CardBus controller 220, the PCI Express endpoints 224, the CardBus endpoint 222, and the PCI endpoint 228, have their configuration spaces, respectively. When the computer system 200 is powered up or booted, the BIOS and the OS will identify the existence of the PCI and the PCI Express devices, and configure the PCI and the PCI Express devices. Each of he PCI and PCI Express devices in the computer system 200 has one function. Actually a particular function in a PCI or PCI Express device may own its unique configuration space. In one embodiment, the configuration space is made up of a set of registers with a capacity of about 4 kilobyte (KB), and a configuration space header of the configuration space occupies the first register. The PCI or PCI express devices of the computer system 200 are mapped into respective configuration spaces with corresponding header types. Configuration space headers of the PCI and PCI Express devices comply with the standards of PCI-SIG “PCI Local Bus Specification Revision 3.0,” PCI-SIG “PCI Express Base Specification Revision 1.1,” and “PCI to PCMCIA CardBus Bridge Register Description—Yenta specification release 2.3” available from Intel Corporation. There are three types of configuration space headers defined in those standards: Type 0 for endpoints, Type 1 for PCI bridges, and Type 2 for CardBus controllers. Data in the configuration space header include hardware information and required resources information, and the BIOS or the OS can acquire these data by reading corresponding bits in the configuration space header.

The BIOS or OS configures a device by writing corresponding configuration space registers of the device. While configuring a device encompasses other aspects, such as setting error handling and interrupt priority, what is taken into consideration herein in this invention is only the system resources assignment or allocation. The resources of the device are address (base address and offset address) assignments for valid ranges of I/O and various memory accesses.

Referring back to FIG. 2, for example, the PCIe-PCI bridge 226, which is coupled to the switch 218, serves as an adaptor and couples the PCI endpoint 228 to a PCI Express port 239(a), and is recognized as configuration space header Type 1.

The PCIe-CardBus controller 220, which is coupled to the RC 204, is used for adapting a CardBus device, such as a CardBus card, to a PCI Express port 235(c), and provides functions to support the CardBus device which is coupled to the CardBus endpoint 222. The functions provided by the PCIe-CardBus controller 220 include providing bus hardware protocol and configuration logic and controlling power of the CardBus socket of the CardBus endpoint 222. As stated above, the CardBus controller is defined as configuration space header Type 2. The PCIe-CardBus controller 220 can be recognized as configuration space header Type 2. All configuration space register's bits of the PCIe-CardBus controller 220 comply with the definitions set out in the foregoing open specifications. As far as the PCIe-CardBus controller 220 is concerned, a flat memory-mapped address space is utilized to access configuration space registers of the PCIe-CardBus controller 220. The detailed definition of mapping from memory address space to the configuration space address of the PCIe-CardBus controller can be found in the foregoing open specifications. The information of resources of the PCIe-CardBus controller 220 is contained in the Type 2 configuration space registers.

The PCI Express endpoints 224, the CardBus endpoint 222, and the PCI endpoint 228 can be associated with corresponding I/O devices and serve as endpoints of the computer system 200. All the endpoints are represented by configuration space header Type 0 according to foregoing open specifications.

In one embodiment, PCI Express links, such as PCI Express buses 240, 242, 246, 250, 252, and 256 shown in FIG. 2, are used to interconnect the modules and devices of the computer system 200 with each other through virtual PCI-to-PCI bridges (virtual P2P bridges). The PCI Express links also are mapped into configuration spaces as the secondary bus of those virtual P2P bridges. For example, the PCI Express buses 242 is coupled to a virtual P2P bridge 234(b) of the RC 204 and a virtual P2P bridge 236 of the switch 218 for interconnecting the RC 204 with the switch 218, and is mapped into a configuration space as the secondary bus of the virtual P2P bridge 234(b) of the RC 204.

The virtual P2P bridges 234(a), 234(b), 234(c) and 234(d) in the RC 204 are logically associated with root ports 235(a), 235(b), 235(c) and 235(d). The root ports 235(a), 235(b), 235(c) and 235(d) are coupled to the host bridge 232 via an internal logical PCI bus 270 in the RC 204, and also coupled to the PCI Express buses 240, 242, 252 and 256, which can be referred to as “peers” or “peer devices.”

The virtual P2P bridges 236, 238(a), and 238(b) in the switch 218 are logically associated with an upstream port 237 and downstream ports 239(a) and 239(b) of the switch 218. The RC 204 is coupled to an internal logical PCI bus 244 of the switch 218 via the upstream port 236 and the PCI Express link 242. The downstream ports 239(a) and 239(b) of the switch 218 are coupled to the internal bus segment 244 via the virtual P2P bridges 238(a) and 238(b), and can be referred to as “peers” or “peer devices”. The downstream ports 239(a) and 239(b) of the switch 218 is used to couple the PCI Express buses 246 and 250 to the internal logical PCI bus 244.

When being configured, devices and buses in the computer system 200 are arranged in a hierarchical topology. Device detection and resource allocation should be from the parent devices to the child devices or from the primary buses to the secondary buses. Referring to FIG. 2, for the PCIe-CardBus controller 220, the PCI Express bus 252 coupled to the CPU 202 through the RC 204 is a higher level primary bus, and a CardBus bus 254 from the PCIe-CardBus controller 220 to the Cardbus endpoint 222 is a lower level secondary bus. The virtual P2P bridge 235(c) of the RC 204 is a parent device of the PCIe-CardBus controller 220, and the PCIe-CardBus controller 220 is a child device of the RC 204. In accordance with one embodiment of the present invention, an ordering principle for detecting the multiple-level buses in the computer system 200 is from higher level buses to lower level buses and one by one from left to right. For example, the RC 204 is the first device to be encountered and numbered. In the RC 204, the host bridge 232 is scanned at first. The internal logical PCI bus 270 behind the host bridge 232 is configured and assigned to a primary number Bus 0. Then, the root ports 234(a), 234(b), 234(c) and 234(d) behind the internal logical PCI bus 270 are scanned such that the PCI Express buses 240, 242, 252, and 256 are numbered. The PCI Express bus 240 which couples the GFX 206 to the RC 204 is configured and assigned to Bus 1. The PCI Express bus 242 is numbered as or assigned to a Bus 2, and then the subordinate buses of the PCI Express bus 242 are numbered. The internal logical PCI bus 244 behind the PCI Express bus 242 is numbered as Bus 3. The PCI Express bus 246 which is the subordinate bus of the PCI bus 244 coupled to the downstream port 239(a) of the switch 218 is numbered as Bus 4. Similarly, the PCIe-PCI bridge 226 is detected, and a PCI bus 248 behind the PCIe-PCI bridge 226 is recognized and numbered as Bus 5. The PCI Express bus 250 which is subordinate bus of the PCI bus 244 is numbered as Bus 6. In such a manner, the PCI Express buses 254 and 256 are numbered with Bus 8 and Bus 9, respectively. Specifically, the PCIe-CardBus controller 220 is detected and assigned to a priority level corresponding to the PCI Express bus 252 which is numbered as Bus 7.

Those skilled in the art will appreciate that other ordering algorithms for detecting buses can also be applied according to other embodiments of the present invention. In another embodiment, the PCIe-CardBus controller 220 can be coupled to the switch 218 so as to be coupled to the RC 204.

When the computer system 200 is actuated or booted, the BIOS of the computer system 200 will detect or configure modules and devices in the computer system 200. For clarity, the detection and configuration process of the PCIe endpoint 224 is taken as an example. When the PCIe endpoint 224 in the computer system 200 is found, the PCIe endpoint 224 will be initialized with a unique bus number, a unique device number and a unique function number, as described hereinabove. The command register in the configuration space of the PCIe endpoint 224, including I/O Space Enable, Memory Space Enable, and Bus Master Enable bits, is set. All required resources, including memory window, prefetchable memory window and I/O window, are set. Alternatively, the setting process of the required resources can be skipped, and then the OS can set default resources for the PCIe endpoint 224. Then, the LegacyBaseAddress is set to a legacy mode I/O base address, and the RegisterBaseAddress and the Interrupt Line register are set.

The reconfiguring process of the PCIe-CardBus controller 220 according to one embodiment of the present invention will be described in detail. At first, the topology of the computer system 200 is rescanned. Thus, the location of the PCIe-CardBus controller 220 is confirmed, and the allocated resources are detected. The total default resources allocated to the top level bus 270 (Bus 0) are detected, and the information of the allocated resources of the top level bus 270 is obtained by reading corresponding registers in the configuration space of the RC 204. Similar to the top level bus 270, the resources allocated by BIOS or OS to the peer devices, such as the PCI Express root ports 235(a), 235(b), 235(c) and 235(d) of the RC 204, are detected. As for the PCIe-CardBus controller 220, resources should be passed to it from the RC 204 through the virtual P2P bridge 234(c). It should be noted that both the PCIe-CardBus controller 220 and the virtual P2P bridge 234(c) do not consume resources. The allocated resources are passed down through the virtual P2P bridge 234(c) and the PCIe-CardBus controller 220 to the CardBus endpoint 222 which is a subordinate device of the PCIe-CardBus controller 220 and is coupled to an I/O device, such as a CardBus card that really consumes resources. The proper resources for the CardBus endpoint 222 associated with the I/O device can be traced back to the top level bus 270.

The allocable resources for the PCIe-CardBus controller 220 are computed. As mentioned above, allocable resources include base address and offset address of the memory, prefetchable memory and I/O. The base address indicates the starting address of resource occupation, while the offset address indicates the limit of window size. It will be appreciated by those skilled in the art that the memory address, prefetchable memory address and I/O address are contiguously assigned and naturally aligned. Free or allocable resources for the PCIe-CardBus controller 220 can be computed by subtracting partial default resources allocated to the peer devices (the virtual P2P bridges 234(a), 234(b) and 234(d)) of the virtual P2P bridge 234(c) from the total default resources of the top level bus 270. For clarity, the memory space window assignment is taken as an example. The computer system 200 owns addressing capability of 4 GB, in which there is a 1 GB of memory window that the CPU 202 assigned to the host bridge 232 of the RC 204 (the top level bus 270). 128 MB of the memory window is passed to the virtual P2P bridge 234(a) which is coupled to the GFX 206 (the PCI Express bus 240), 256 MB of the memory window is passed to the virtual P2P bridge 234(b) which is coupled to the switch 218 (the PCI Express bus 242), 1 MB is passed to the virtual P2P bridge 234(c) which is coupled to the PCIe-CardBus controller 220 (the PCI Express bus 252), and 1 MB is passed to the PCI Express endpoint 224 which is coupled to the RC 204 through the virtual P2P bridge 234(d) (the PCI Express bus 256). There is only 1 MB of the 1 GB of memory window that is allocated to the virtual P2P bridge 234(c). The available remaining resources are 638 MB (1024−128−256−1−1=638 MB). As such, although there is only 1 MB of memory allocated to the virtual P2P bridge 234(c) previously, there now are actually 638+1=639 MB of memory window available for re-assignment when the virtual P2P bridge 234(c) needs memory window larger than 1 MB. The approach of detection also can be applied to prefetchable memory window assignment and I/O window assignment. Nevertheless, it should be noted that since the I/O windows for virtual P2P bridge must be aligned on 4 KB boundaries in I/O space, windows must be assigned to the virtual P2P bridges at multiples of 4 KB in I/O space.

In succession, parent resources, including memory window, prefetchable memory window, I/O window and the base addresses thereof, for the virtual P2P bridge 234(c) is updated and reassigned on demand. For example, a 2 MB of memory window and a 4 KB of I/O window are allocated to the virtual P2P bridge 234(c) which is coupled to the PCIe-CardBus controller 220. When the PCIe-CardBus controller 220 needs memory window and I/O window more than 2 MB and 4 KB, respectively, available remaining resources can be reassigned to the virtual P2P bridge 234(c), as long as the reassigned resources are within the range of available resources.

Finally, child resources for the PCIe-CardBus controller 220 are updated and re-allocated. Those skilled in the art will appreciate that the child resources passed to the child devices must be within the range of the parent resources of the parent devices. Since the virtual P2P bridge 234(c) which is the parent device of the PCIe-CardBus controller 220 is reassigned sufficient resources, the PCI Express bus 252 can be updated along with the virtual P2P bridge 234(c) of the RC 204. The PCI Express bus 252, the primary bus of the PCIe-CardBus controller 220, passes available resources to the PCIe-CardBus controller 220. As such, resources for the PCIe-CardBus controller 220 are updated and re-allocated. In one embodiment, all of parent resources allocated to the virtual P2P bridge 234(c) of the RC 204 can be passed to the PCIe-CardBus controller 220. The PCIe-CardBus controller 220 receives maximum available resources to operate and pass to its child devices. When a CardBus card coupled to the CardBus endpoint 222, it can obtain sufficient child resources from the PCIe-CardBus controller 220 to start up and work correctly. When the reconfiguration is finished, the Memory Space Enable, I/O Space Enable, and Bus Master Enable bits in the command register of the PCIe-CardBus controller 220 are set. The reconfiguration program can be implemented either in BIOS or in a custom-built software driver, according to different embodiments of the present invention.

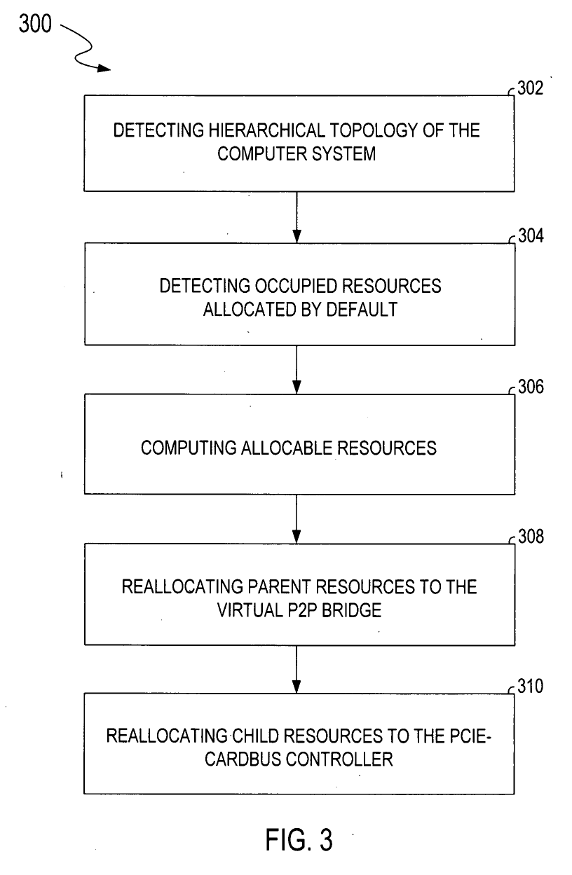

Referring to FIG. 3, a method 300 for dynamically and adaptively reconfiguring a PCIe-CardBus controller in a computer system which complies with PCI Express standard is illustrated, in accordance with one embodiment of the present invention. Those skilled in the art will appreciate that a device in the computer system which is structured with a Peripheral Component Interconnect Express (PCI Express) bus, such as a PCIe-CardBus controller, will be set to an un-initialized state when the computer system initially is activated or started up. A BIOS of the computer system is actuated to boot up the computer system.

As shown in FIG. 3, at 302, the hierarchical topology of the computer system is detected for building a device tree. When the devices of the computer system are detected, all the devices, including the PCIe-CardBus controller, are defined and numbered for establishing the device tree. The device tree of all buses and devices in the computer system is a software representation of the hierarchical topology relationship. System software writes numbers into respective configuration space headers of the devices so as to establish the device tree according to those numbers. The written device numbers, as well as bus numbers and function numbers, can be read out in corresponding configuration space headers of the devices. After all the devices of the computer system are configured, default resources will be allocated by the BIOS or the OS for software-driven initialization and configuration. The resources of the devices of the computer system include address (base address and offset address) assignments for valid ranges of I/O and various memory accesses.

At 304, default resources allocated by the BIOS or the OS are detected. By reading address registers in a configuration space of a root complex (RC) of the computer system, total default resources allocated to the top level bus are detected. Similar to the top level bus, the resources allocated by BIOS or OS to peer devices, such as PCI Express root ports of the RC, are detected by reading corresponding address registers in configuration space of the devices coupled to the root ports. As for the PCIe-CardBus controller, the resources information is contained in the Type 2 configuration space registers of the PCIe-CardBus controller. The default resources are passed to the PCIe-CardBus controller from the RC through a virtual P2P bridge in one of the root ports. Partial default resources are allocated from the total default resources to the virtual P2P bridges of the root ports which are not coupled to the PCIe-CardBus controller.

At 306, the allocable resources for the PCIe-CardBus controller are computed. The resources, for example, include base address and offset address of the memory, prefetchable memory and I/O. Because the memory address, prefetchable memory address and I/O address are contiguously assigned and naturally aligned, free or allocable resources can be computed by subtracting partial default resources allocated to the peer devices of the virtual P2P bridge that coupled to the CardBus controller from the detected total default resources of the top level bus. The remaining resources which are not occupied are available for the PCIe-CardBus controller.

At 308, parent resources, including memory window, prefetchable memory window, I/O window and the base addresses thereof, for the parent device of the PCIe-CardBus controller (one virtual P2P bridge in the RC) is updated and reassigned on demand. For example, the PCIe-CardBus controller is coupled to one of the ports of the RC, and a 2 MB of memory window and a 4 KB of I/O window are allocated to the virtual P2P bridge of the one of the root ports of the RC. When the PCIe-CardBus controller needs memory window and I/O window more than 2 MB and 4 KB, respectively, available remaining parent resources can be reassigned to the virtual P2P bridge, as long as the reassigned resources are within the range of the available resources computed at 306.

At 310, child resources for the PCIe-CardBus controller is updated and re-allocated. Since the virtual P2P bridge of the RC as the parent device of the PCIe-CardBus controller is reassigned sufficient resources at 308, the available resources can be passed to the PCIe-CardBus controller via the virtual P2P bridge and the resources for the PCIe-CardBus controller are updated and re-allocated. In one embodiment, all of parent resources allocated to the virtual P2P bridge can be passed to the PCIe-CardBus controller. As such, the PCIe-CardBus controller receives maximum available resources to operate and pass to its child devices. When a CardBus card coupled to the CardBus endpoint, it can obtain sufficient resources from the PCIe-CardBus controller to start up and Work correctly.

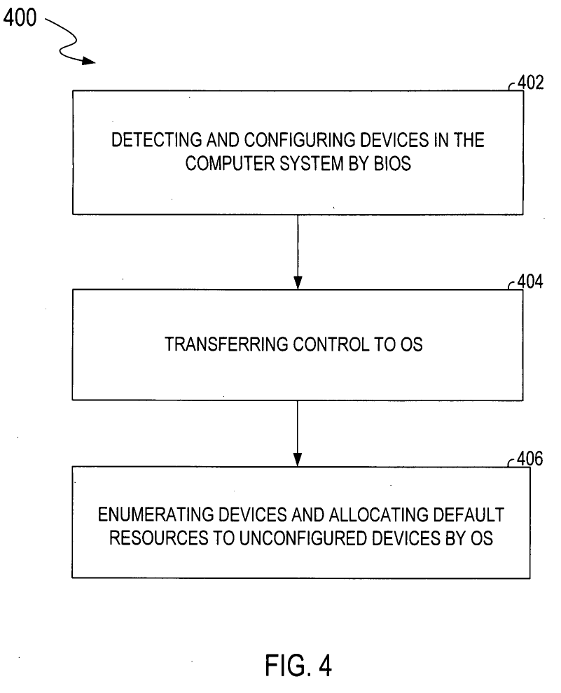

Referring to FIG. 4, a method 400 for configuring a complete computer system is illustrated, according to one embodiment of the present invention. In this embodiment, the method 400 as shown in FIG. 4 is applied to a PCI Express-based computer system along with an operating system of Windows 2000® or Windows XP® system. The method 300 for dynamically reconfiguring a PCIe-CardBus controller is coded or programmed into the BIOS firmware in the PCI Express-based computer system.

At 402, the devices of the computer system is detected and configured by the BIOS. When the computer system is powered or booted up, devices in the computer system are found and initialized with unique bus numbers. A command register in the configuration space of any one of the devices is set, including I/O Space Enable, Memory Space Enable, and Bus Master Enable bits. Optionally, required resources, including memory window, prefetchable memory window and I/O window, then are set. The LegacyBaseAddress is set to a legacy mode I/O base address, the RegisterBaseAddress is set, and the Interrupt Line register is set. Then, the method for dynamically reconfiguring a PCIe-CardBus controller is executed to allocate resources to an I/O device of a Cardbus endpoint of the PCIe-CardBus controller. After executing the BIOS of the computer system, the PCIe-CardBus controller is set to PC Card I/O Card (PCIC) mode by default, so that the OS will be able to determine which ISA (Industry Standard Architecture) interrupts are attached to the PCIe-CardBus controller before the BIOS transfer control to an operating system.

At 404, the BIOS transfers control to the operating system. A system file for configuring hardware information of the computer system in the operating system such as NTDetect.com is loaded and runs a scan to identify ISA interrupts for supporting R2 cards coupled to the CardBus endpoint. After the system file scanning the ISA interrupts, the PCIe-CardBus controller will not be in the PCIC mode. Then, an Advanced Configuration and Power Interface (ACPI) will be started. The ACPI is a power management specification that allows the OS to control the amount of power distributed to devices in the computer system. When the operating system calls a system method such as the _INI control method to put the PCIe-CardBus controller in CardBus mode, an ACPI driver is supported. The operating system uses the ACPI driver to manage the devices of the computer system.

At 406, the operating system enumerates devices in the computer system and assigns default resources to un-configured devices. The topology of the computer system is rescanned and un-configured devices therein are detected in the enumeration. The ACPI hands over the domination to the operating system, and the operating system continues the boot-up process.

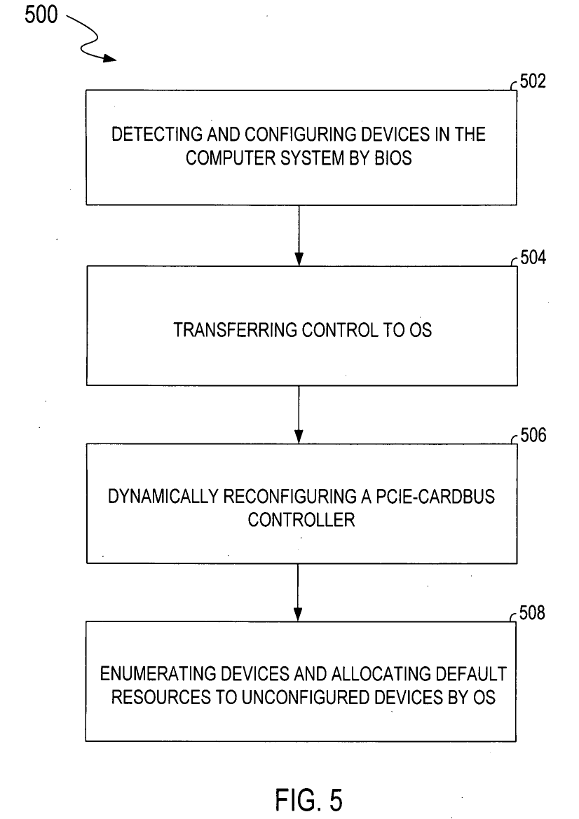

Referring to FIG. 5, another method 500 for configuring a computer system is illustrated, according to another embodiment of the present invention. In this embodiment, the method 500 as shown in FIG. 5 is applied to a PCI Express-based computer system along with an operating system of Windows 2000® or Windows XP® system. The method 300 for dynamically reconfiguring a PCIe-CardBus controller is coded or programmed into a custom-built software driver, and the custom-built software driver is installed in an operating system.

At 502, the devices of the computer system is detected and configured by the BIOS. When the computer system is powered or booted up, devices in the computer system are found and initialized with unique device numbers. A command register in the configuration space of any one of the device is set, including 1/0 Space Enable, Memory Space Enable, and Bus Master Enable bits. After executing the BIOS of the computer system, the PCIe-CardBus controller is set to PC Card I/O Card (PCIC) mode by default, so that the OS will be able to determine which ISA (Industry Standard Architecture) interrupts are attached to the PCIe-CardBus controller before the BIOS transfer control to the operating system.

At 504, the procedure is similar to the procedure at 404 shown in FIG. 4, and the BIOS transfers control to the operating system. A PCI driver of the operating system will be loaded.

At 506, the custom-built software driver with the coding of method 300 for dynamically reconfiguring a PCIe-CardBus controller is actuated or executed. The CardBus card coupled to the CardBus endpoint of the computer system can obtain sufficient resources from the PCIe-CardBus controller to start up and work correctly.

At 508, the operating system enumerates devices in the computer system and assigns default resources to un-configured devices. The topology of the computer system is rescanned and un-configured devices therein are detected in the enumeration. The ACPI hands over the domination to the operating system, and the operating system continues the boot-up process.

According to other embodiments of the present invention, any type of devices that can not be configured correctly or assigned with sufficient default resources by the BIOS and OS can be re-allocated adequate resources according to the method 300, 400 and 500 show in FIG. 3, FIG. 4 and FIG. 5.

While the foregoing description and drawings represent the preferred embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A method for configuring a computer system, comprising the steps of:
allocating a first plurality of default resources to a plurality of devices of said computer system;
reconfiguring a PCIe-CardBus controller with a plurality of allocable resources that are available to said PCIe-CardBus controller in said computer system;
enumerating said plurality of devices of said computer system by an Operating System (OS) of said computer system for detecting a plurality of un-configured devices in said computer system; and
allocating a second plurality of default resources by said OS to said plurality of un-configured devices.

2. The method of claim 1, wherein said step of reconfiguring further comprising the steps of:
detecting said first plurality of default resources occupied by said plurality of devices of said computer system;
computing said plurality of allocable resources which are available; and
re-allocating said plurality of allocable resources to said PCIe-CardBus controller.

3. The method of claim 2, wherein said step of reconfiguring further comprising the step of:
detecting a topology of said computer system for defining a top level bus and a root complex from said plurality of devices of said computer system wherein said root complex comprising a plurality of virtual PCI-to-PCI bridges and one of said plurality of virtual PCI-to-PCI bridges being capable of coupling said PCIe-CardBus controller to said root complex.

4. The method of claim 3, wherein said step of computing said plurality of allocable resources further comprising the step of:
subtracting a plurality of partial default resources occupied by a plurality of peer devices of said virtual PCI-to-PCI bridge from a plurality of total default resources occupied by said top level bus for obtaining said plurality of allocable resources.

5. The method of claim 2, wherein said step of re-allocating said plurality of allocable resources further comprising the steps of:
allocating a plurality of predetermined parent resources from said plurality of allocable resources to one of said plurality of virtual PCI-to-PCI bridges which is coupled to said PCIe-CardBus controller; and
allocating a plurality of predetermined child resources from said plurality of predetermined parent resources to said PCIe-CardBus controller.

6. A computer system capable of re-allocating a plurality of allocable resources to a PCIe-CardBus controller, comprising:
a Central Processing Unit (CPU) for managing a plurality of devices of said computer system, wherein said plurality of devices comprising said PCIe-CardBus controller;
a Basic Input Output System (BIOS) for cooperating with said CPU to boot up said computer system and load an operating system; and
a root complex coupled to said CPU and having a plurality of root ports associated with a first plurality of virtual PCI-to-PCI bridges, wherein one of said first plurality of virtual PCI-to-PCI bridges being capable of coupling said PCIe-CardBus controller to said root complex,
wherein said BIOS being capable of allocating a plurality of default resources to said plurality of devices of said computer system, computing said plurality of allocable resources which are available, and re-allocating said plurality of allocable resources to said PCIe-CardBus controller.

7. The computer system of claim 6, further comprising:
a switch coupled to said root complex and comprising an upstream port and a plurality of downstream ports which being associated with a second plurality of virtual PCI-to-PCI bridges; and
a second PCIe-CardBus controller coupled to said switch via one of said second plurality of virtual PCI-to-PCI bridges.

8. The computer system of claim 6, wherein said plurality of allocable resources comprising:
a predetermined window size and a base address of memory;
a predetermined window size and a base address of prefetchable memory; and
a predetermined window size and a base address of I/O.

9. A computer system capable of re-allocating a plurality of allocable resources to a PCIe-CardBus controller, comprising:
a Central Processing Unit (CPU) for managing a plurality of devices of said computer system, wherein said plurality of devices comprising said PCIe-CardBus controller;
a Basic Input Output System (BIOS) for cooperating with said CPU to boot up said computer system;
an operating system;
a root complex coupled to the CPU and having a plurality of root ports associated with a first plurality of virtual PCI-to-PCI bridges, wherein one of said first plurality of virtual PCI-to-PCI bridges being capable of coupling said PCIe-CardBus controller to said root complex; and
a software driver installed in said operating system being capable of detecting a first plurality of default resources occupied by said plurality of devices of said computer system, computing said plurality of allocable resources which are available, and re-allocating said plurality of allocable resources to said PCIe-CardBus controller.

10. A method for reconfiguring one of a plurality of devices in a computer system, said method comprising the steps of:
detecting a plurality of default resources occupied by said plurality of devices of said computer system;
computing a plurality of allocable resources which are available; and
re-allocating said plurality of allocable resources to said device of said computer system.

11. The method of claim 10, further comprising the step of:
detecting a topology of said computer system for defining a top level bus, a parent device of said device, and a plurality of peer devices of said parent device of said device from said plurality of devices of said computer system.

12. The method of claim 11, wherein said step of computing said plurality of allocable resources further comprising the step of:
subtracting a plurality of partial default resources occupied by said plurality of peer devices from a plurality of total default resources occupied by said top level bus for obtaining said plurality of allocable resources.

13. The method of claim 11, wherein said step of re-allocating said plurality of allocable resources further comprising the steps of:
allocating a plurality of predetermined parent resources from said plurality of allocable resources to said parent device of said device; and
allocating a plurality of predetermined child resources from said plurality of predetermined parent resources to said device.

14. The method of claim 11, wherein said parent device of said device being a virtual PCI-to-PCI bridge in a root complex.

15. The method of claim 10, wherein said computer system complying with Peripheral Component Interconnect Express (PCI Express) industry bus standard.

16. The method of claim 10, wherein said one of said plurality of devices being a PCIe-CardBus controller.
